(19) United States
(12) Patent Application Publication
(10) Pub. No.: US 2016/0333455 A1
(43) Pub. Date: Nov. 17, 2016

(54) Thermal Barrier Coating with Lower Thermal Conductivity

(71) Applicant: Pratt & Whitney Canada Corp., Longueuil (CA)

(72) Inventor: Joel Larose, Longueuil (CA)

(73) Assignee: Pratt & Whitney Canada Corp., Longueuil (CA)

(21) Appl. No.: 15/223,496

(22) Filed: Jul. 29, 2016

Related U.S. Application Data
(63) Continuation of application No. 14/029,104, filed on Sep. 17, 2013.
Application No. 14/029,104 is a continuation of application No. 12/718,518, filed on Mar. 5, 2010, now abandoned.
(60) Provisional application No. 61/158,144, filed on Mar. 6, 2009.

(51) Int. Cl. C23C 4/134; C23C 4/11; F02C 7/12; F01D 25/00; F01D 9/04; F01D 11/00; C23C 4/02; C23C 4/131

(52) U.S. Cl. CPC C23C 4/134; C23C 4/02; C23C 4/11; C23C 4/131; F01D 25/005; F01D 9/041; F01D 11/00; F02C 7/12; F05D 2300/611; F05D 2240/12; F05D 2240/35; F05D 2240/55; F05D 2300/2118; F05D 2300/171; F05D 2300/17; F05D 2230/90

(57) ABSTRACT

A thermal barrier coating includes a microstructure and a composition including: a ceramic based compound comprising gadolinia and zirconia. The coating includes a nano-structure having a porosity of at most 50% by volume of the coating.

### CROSS-REFERENCE TO RELATED APPLICATIONS

This is a continuation application of U.S. patent application Ser. No. 14/029,104, filed Sep. 17, 2013 and entitled “Thermal Barrier Coating with Lower Thermal Conductivity” which is a continuation of U.S. patent application Ser. No. 12/718,518, filed Mar. 5, 2010, and entitled “Thermal Barrier Coating with Lower Thermal Conductivity” and benefit is claimed of Ser. No. 61/158,144, filed Mar. 6, 2009, and entitled “Thermal Barrier Coating with Lower Thermal Conductivity”, the disclosures of which are incorporated by reference herein in their entirety as if set forth at length.

### BACKGROUND OF THE INVENTION

The present application relates generally to a thermal barrier coating (TBC) and a process for applying a TBC to a substrate.

A thermal barrier coating is designed to protect a surface on which it is applied from a high temperature, by increasing the resistance to heat transfer. Such coatings have low thermal conductivities and are deposited onto a variety of surfaces of metal parts, particularly those exposed to high temperature gradients.

There have been to date two distinct and alternate approaches taken to producing thermal barrier coatings, both having the goal of reducing the thermal conductivity of the coating itself and thus of the part to which the coating is applied. A first approach is based on changing the elemental composition of the TBC to reduce thermal conductivity of TBC. A second alternate approach uses a decrease in the size of the heterogeneities within the coating to reduce the thermal conductivity of a TBC. Each of these alternate approaches has been used in a mutually exclusive fashion, those skilled in the art essentially selecting either one or the other approach depending on the desired application and part being coated.

There however remains a need for improved thermal barrier coatings.

### SUMMARY OF THE INVENTION

There is provided a thermal barrier coating for application to a substrate comprising: a ceramic based compound comprising gadolinia and zirconia and wherein the coating comprises a nano-structure having a porosity of at most 50% by volume of the coating.

There is also provided a process for applying a thermal barrier coating onto a substrate, the process comprising: providing a particulate ceramic based compound comprising gadolinium zirconate; grading the particulate ceramic based compound to produce graded particles comprising nanosized particles, wherein the nanosized particles have an average diameter from 2 and 400 nm; collecting the graded particles; at least partially melting an outer surface of a majority of the graded particles; and applying the partially melted graded particles onto the substrate to produce the coating comprising a porosity of at most 50% by volume of the coating.

The process may also include providing a porosity of the thermal barrier coating that is at most 20% by volume of the coating.

The process may also include providing the substrate, the substrate including at least one of an airfoil, any part having a seal, a seal, and a combustion chamber liner for a gas turbine engine.

The process may also include applying the thermal barrier coating to a thickness in the range of from about 1.0 to about 15 mils.

The process may also include providing the substrate which is a surface of at least one of an airfoil, a seal, and a combustion chamber liner of a gas turbine engine.

The process may also include providing the substrate which includes at least the airfoil of a turbine vane of a gas turbine engine.

The process may also include providing the substrate which is composed of a material selected from the group consisting of nickel based alloy, cobalt based alloy, steel alloy, and molybdenum based alloy.

The process may also include providing a metallic bond coat disposed between the substrate and the thermal barrier coating, the metallic bond coat may have a thickness in the range of from about 0.5 to about 20 mils, and more preferably a thickness in the range of from about 0.5 to about 10 mils.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a schematic representation of a coated substrate including a thermal barrier coating according to a preferred embodiment defined herein;

FIG. 2 is a flowchart representing a process of applying a thermal barrier coating to a substrate according to a preferred embodiment described herein; and

FIG. 3 is a schematic cross-sectional view of a gas turbine engine having a component to which the present thermal barrier coating is applied.

Like reference numbers and designations in the various drawings indicate like elements.

### DETAILED DESCRIPTION

The present thermal barrier coating (TBC) is designed to increase the resistance to thermal transfer through a wall subjected to a thermal gradient. Any reduction in the TBC thermal conductivity will lead to a higher resistance to heat transfer and thus a reduction in the underlying substrate temperature. This increased resistance to heat transfer enables either lower metal temperature for a given combustion gas temperature (for increased durability) or an increased combustion gas temperature for an equivalent metal temperature (for decreased specific fuel consumption).

The TBC described herein is aimed at reducing thermal conductivity of a TBC by employing a combination of both a nano-structured microstructure and a change in chemical composition over standard TBC used in current state-of-the-art turbomachinery applications. This combination enables further reduction of the thermal conductivity compared to the use of either nano-structured standard TBC compositions or a different TBC chemical composition with a standard-size microstructure.

The present TBC and the application process thereof combines the benefits of both a chemical composition adjustment and a decrease in the size of the heterogeneities by producing a nano-structured coating microstructure to form a thermal barrier coating. The chemical composition adjustment of a thermal barrier coating is described for example in US2008/0057326A1, US2008/0044686A1, US2008/0138658A1, US2008/0176097A1, US2007/0172703A1, U.S. Pat. No. 7,455,913B2, US2008/0113217A1, U.S. Pat. No. 6,117,560A, U.S. Pat. No. 6,177,200B1, U.S. Pat. No. 6,231,991B1 and U.S. Pat. No. 6,284,323B1, the content of each of which is incorporated herein by reference. Decreasing the size of homogeneities within a TBC coating microstructure is described for example in US2008/0167173A1, the content of which is also incorporated herein by reference.

Combination of both effects, namely a chemical composition adjustment and a decrease in the size of the heterogeneities by producing a nano-structured coating microstructure, thereby reduces thermal conductivity further than a single coating method alone and thus provide an additional benefit over TBCs relying on only one of these techniques, previously only used in a mutually exclusive manner, to further reduce their resistance to heat transfer. This coating may be deposited on any metallic substrate, with or without the use of a bond coat.

As used herein, the term “thermal barrier coating” is a layer applied on a substrate that has a composition comprising at least one ceramic based compound having at least one metal capable of reacting with silicates, and exhibits a coefficient of thermal expansion value sufficient for use in any turbomachinery application. In a preferred embodiment the substrate to which the TBC is applied may include a high temperature or “hot end” part for a gas turbine engine, such as a turbine blade, turbine vane, other airfoil surface or a combustion chamber liner, for example. In a particular embodiment, the substrate to which the TBC is applied may be formed from a material selected from the group consisting of a nickel based alloy, a cobalt based alloy, and a molybdenum based alloy.

The coating as defined herein is understood to comprise a nano-structure. Nano-structure is defined in context of the ceramic based compound and describes the morphology of the microstructure of the compound that includes nano-sized (in a range of 1 to 999 nm) heterogeneities, particularly, porous inclusions into the ceramic based compound structure small size.

The term graded is defined herein as a separation of particles into various particle size fractions. Grading can be accomplished by sieving or by screening.

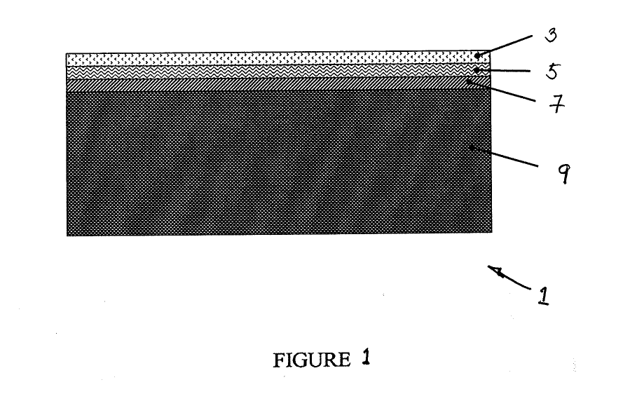

Referring now to FIG. 1, a coated article 1 includes a thermal barrier 3 that is applied over a substrate 9, and may also be coated with an optional interlayer 5 and an optional bond coat 7 material disposed between the TBC 3 and the underlying substrate 9. The thicknesses of thermal barrier coatings may vary but are generally in a range from 100 to 300 μm. The metallic bond coat 7 disposed between the substrate and the TBC may have a thickness in the range of from about 0.5 to 20 mils, and more preferably a thickness in the range of from about 0.5 to about 10 mils.

The bond coat material may comprise a formula MCrAlY. MCrAlY refers to known metal coating systems in which M denotes nickel, cobalt, iron, their alloys, and mixtures thereof; Cr denotes chromium; Al denotes aluminum; and Y denotes yttrium. MCrAlY materials are often known as overlay coatings because they are applied in a predetermined composition and do not interact significantly with the substrate during the deposition process. An example of an MCrAlY bond coat composition is described in U.S. Pat. No. Re. 32,121, which is incorporated herein by reference, as having a weight percent compositional range of 5-40 Cr, 8-35 Al, 0.1-2.0 Y, 0.1-7 Si, 0.1-2.0 Hf, balance selected from the group consisting of Ni, Co and mixtures thereof. See also U.S. Pat. No. 4,585,481, which is incorporated herein by reference.

The bond coat material may also comprise Al, PtAl and the like, that are often known in the art as diffusion coatings. In addition, the bond coat material may also comprise Al, PtAl, MCrAlY as described above, and the like, that are often known in the art as overlay coatings.

The MCrAlY bond coat may be applied by any method capable of producing a dense, uniform, adherent coating of the desired composition, such as, but not limited to, diffusion bond coat, cathodic arc bond coat, etc. Such overlay coating techniques may include, but are not limited to, diffusion processes (e.g., inward, outward, etc.), low pressure plasma-spray, air plasma-spray, sputtering, cathodic arc, electron beam physical vapor deposition, high velocity plasma spray techniques (e.g., HVOF, HVAF), combustion processes, wire spray techniques, laser beam cladding, electron beam cladding, etc.

The particle size for the bond coat 7 may be of any suitable size, and in embodiments may be between about 15 microns (0.015 mm) and about 60 microns (0.060 mm) with a mean particle size of about 25 microns (0.025 mm). The bond coat 30 may be applied to any suitable thickness, and in embodiments may be about 0.5 mils (0.0127 mm) to about 20 mils (0.508 mm) thick. In some embodiments, the thickness may be about 6 mils (0.152 mm) to about 7 mils (0.178 mm) thick.

For increased resistance to coating delamination and spallation, an interlayer 5 can optionally be added between the bond coat 7 and the TBC 3. This interlayer 5 is usually composed of zirconium oxide stabilized by yttrium oxide is particularly preferred. Yttrium oxide stabilized zirconium oxide has a general formula of ZrO₂-x wt % Y₂O₃, where x is preferably about 5-20 wt %, more preferably about 6-8 wt %.

A composition of particular ceramic compound ingredients produces a thermal barrier coating at on either the substrate 9, the bond coat 7, or the interlayer 5. The article 1 may comprise any part that is typically coated with a thermal barrier composition and, in particular, may comprise a part used in turbomachinery applications such as, but not limited to, any part having an airfoil, such as turbine blades, vanes, etc., as well as any part having a seal, combustion chamber liners and the like.

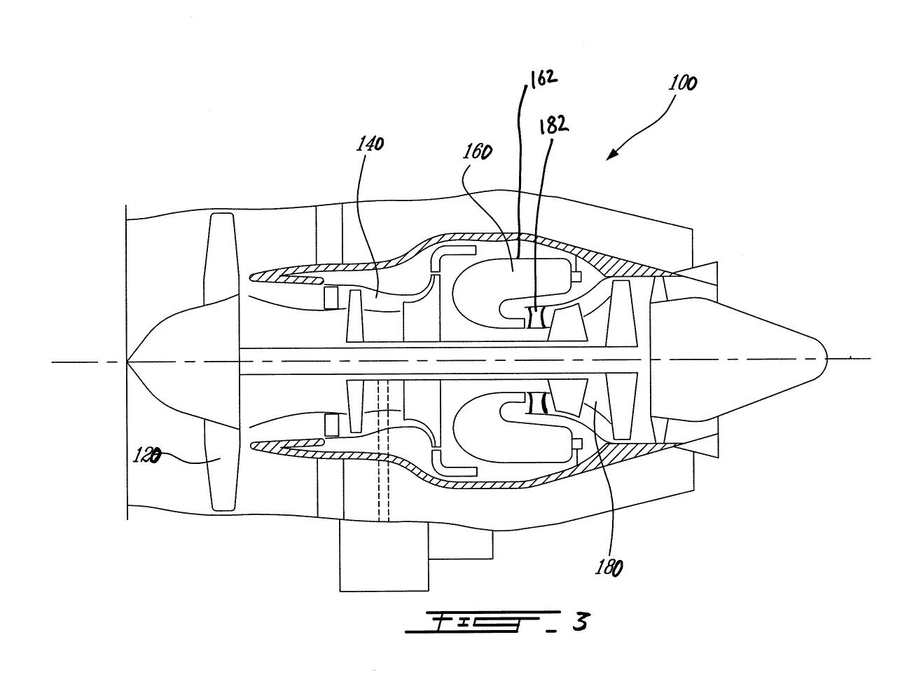

Accordingly, referring to FIG. 3 which illustrates a turbofan gas turbine engine 100 of a type preferably provided for use in subsonic flight, the substrate 1 to which the TBC 3 is applied may include one or more components of the gas turbine engine 100, such as, for example only, a high pressure turbine vane 182 of the turbine section 18 and/or the combustion chamber liner 162 of the combustor 160. As seen in FIG. 3, the gas turbine engine 100 generally includes, in serial flow communication, a fan 12 through which ambient air is propelled, a multistage compressor 14 for pressurizing the air, a combustor 16 in which the compressed air is mixed with fuel and ignited for generating an annular stream of hot combustion gases, and a turbine section 18 for extracting energy from the combustion gases.

The thermal barrier composition may be applied to the article 1 using any number of processes known to one of ordinary skill in the art. However, care should be taken to ensure that the method used includes a partial melting of the composition. Suitable heating/application processes include, but are not limited to, thermal spray (e.g., air plasma, high velocity oxygen fuel), combinations comprising at least one of the foregoing processes, and the like. In a preferred embodiment, the composition producing the TBC may comprise at least one ceramic based compound, having at least one metal, including metal oxides. As recognized by one of ordinary skill in the art, a thermal barrier coating applied via a thermal spray process exhibits a tortuous, interconnected porosity due to the splats and micro cracks formed via the thermal spray process. One particular TBC application method is Air Plasma Spray coating (APS) that produces nano-structured inclusions.

A TBC system is usually comprised of 2 layers. The first layer is generally a metallic bond coat (BC), which is deposited directly (via thermal spray) on the metallic surface of the blades and combustion chambers. The BC layer (coating) is usually made of MCrAlY alloys and the typical BC thickness varies from 100 to 250 microns. The main function of the BC is to protect the metallic parts of the turbine against high temperature oxidation and to serve as a support coating or anchor coating for the second layer. The second layer (also known as top coat, or TC) deposited (via thermal spray) on the BC layer. The main function of the ceramic top coat, due to its inherent mechanical integrity, stability, low thermal conductivity and chemical resistance up to high temperatures, is to protect the metallic parts of the turbine against the high temperature environment of the combustion of fuel in the turbine engine. With the use of TBCs it is possible to increase the compressor and combustion chamber efficiencies (by burning fuel at higher temperatures) and decrease fuel consumption. Today, most of the aviation and land based gas turbines make use of TBCs.

Aforementioned low conductivity ceramics typically exhibit lower fracture toughness and delamination resistance than the coatings made of zirconium oxide stabilized by yttrium oxide. For increased resistance to coating delamination and spallation, a third layer (labelled interlayer in FIG. 1) can be added between the BC and the TC. This interlayer is usually composed of zirconium oxide stabilized by yttrium oxide is particularly preferred. Yttrium oxide stabilized zirconium oxide has a general formula of ZrO₂-x wt % Y₂O₃, where x is preferably about 5-20 wt %, more preferably about 6-8 wt %.

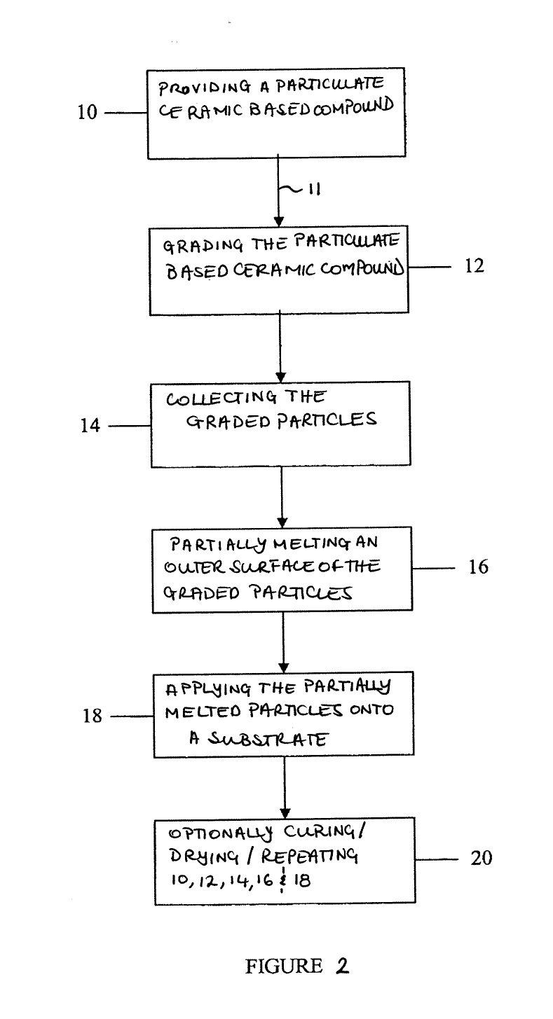

Referring now to FIG. 2, the first step of the process is providing a particulate ceramic based material 10. Various methods of providing a particulate ceramic based compound 10 are known to the skilled person in the art. The particulate ceramic based compound 11 comes in various size fractions that are 10 to 300 μm, and preferably from 50 to 200 μm.

This particulate ceramic based compound 11 material provided may be of at least one ceramic based compound comprising at least one oxide of a material metal selected from the group consisting of lanthanum, cerium, praseodymium, neodymium, promethium, samarium, europium, gadolinium, terbium, dysprosium, holmium, erbium, thulium, ytterbium, lutetium, indium, scandium, yttrium, zirconium, hafnium, titanium, and mixtures thereof. For example, the ceramic based compound may comprise at least gadolinia-zirconia in combination with at least one other oxide. In at least one particular embodiment, the compound comprises 5-60 mol % of gadolinia.

Importantly, sand related distress is caused by the penetration of molten sand into the thermal barrier coatings that leads to spallation and accelerated oxidation of any exposed metal. It has been discovered that certain coatings react with fluid sand deposits and a reaction product forms that inhibits fluid sand penetration into the coating. The reaction product has been identified as being a silicate oxypatite garnet containing primarily gadolinia, calcia, zirconia, and silica. For additional resistance of the coating to fluid sand penetration (molten silicate), the coating can be doped from about 25-100 wt % of at least one oxide. The material is mixed with, and preferably contains, from about 25 to 99 wt %, preferably from about 40-70 wt %, of at least one oxide of a metal selected from the group consisting of lanthanum, cerium, praseodymium, neodymium, promethium, samarium, europium, gadolinium, terbium, dysprosium, holmium, erbium, thulium, ytterbium, lutetium, scandium, indium, and yttrium. Another alternative would be to provide molten silicate resistance by coating the TBC with a zirconia, hafnia, or titania based coating with at least one oxide selected from the group consisting of lanthanum, cerium, praseodymium, neodymium, promethium, samarium, europium, gadolinium, terbium, dysprosium, holmium, erbium, thulium, ytterbium, lutetium, scandium, and indium as a stabilizing element.

Other preferred compositional embodiments of the ceramic based compound of the thermal barrier coating include:
gadolinia-zirconia alone or in combination with at least one oxide of a material selected from the group consisting of lanthanum, cerium, praseodymium, neodymium, samarium, europium, terbium, dysprosium, holmium, erbium, thulium, ytterbium, lutetium, indium, scandium, yttrium, zirconium, hafnium, titanium, and combinations thereof;
gadolinia-zirconia alone or in combination with at least one oxide of a material selected from the group consisting of lanthanum, cerium, neodymium, indium, scandium, yttrium, zirconium, titanium, and combinations thereof;
gadolinia-zirconia alone or in combination with at least one oxide of a material selected from the group consisting of yttrium, zirconium and combinations thereof; and/or
gadolinia-zirconia alone or in combination with at least another metallic oxide comprising a metal selected from the group consisting of lanthanum, cerium, praseodymium, neodymium, samarium, europium, terbium, dysprosium, holmium, erbium, thulium, ytterbium, lutetium, indium, scandium, yttrium, zirconium, hafnium, titanium, and combinations thereof; zirconate, lanthanum zirconate, neodymium titanate, and gadolinium hafnate.

With each of these compositional embodiments of the thermal barrier coating optionally comprising at least one of zirconate, lanthanum zirconate, neodymium titanate, and gadolinium hafnate.

The second of the process is grading 12 the particulate based ceramic compound typically with particles in the range previously mentioned of 10 to 300 μm, and preferably from 50 to 200 μm. However it is important to have nanosized particles having an average diameter from 2 and 400 nm, and preferably from 10 to 200 nm within the larger (micron sized) graded particles. The third step of collecting 14 the graded material involves having the correct fraction and preparing the fraction for thermal deposition.

The fourth and fifth steps are commonly done together but here will be described separately because an important feature of the present of the TBC described herein is the understanding that the graded particle must be partially melted 16 on an outer surface while their central core area remains generally solid. This is achieved by very short exposure times to the high temperature thermal source such as a combustion flame or a plasma.

Thus decreasing the size of the heterogeneities can be achieved by spraying agglomerated ceramic nanoparticles feedstock. Thermal spraying in a controlled manner using spray conditions that only partially melt the exterior surfaces of the ceramic based compound particles. The heating is preferably such that the molten material does not infiltrate by capillarity into the network of porosity of the non-molten core portion of the particles (porous nanostructured inclusions) is preferred. The present process provides that at least a majority (more than 50% of all particles) are partially melted.

The partially melted graded ceramic particles, are then applied 18 or deposited onto a substrate. The partially melted graded ceramic particles retain unmelted or semi-molten porous cores, resulting in the various nano-structured inclusions distributed within the coating. These inclusions or pores, become features of the coating microstructure. Therefore, in addition to the voids that are normally observed in thermally sprayed materials, i.e. coarse pores formed by the imperfect packing of thermally sprayed particles, and fines pores, located in between two adjacent thermal spray splats, there is a third type porous nanostructured inclusions that are small generally spheroid in nature and have a size similar to that of the nanosized particle of from 2 to 400 nm from which they derive, but are voids of porosity or heterogeneity. This additional porosity is thought to lower the conductivity of the compound further due to the poor conductivity of the gas within the numerous pores. The percentage of surface area covered by these three types of inclusions is from 20% to 75% of the total surface area of the coating. The porosity of the coating may be as high as 50% by volume but in a preferred embodiment is 20% by volume of the coating.

In a preferred embodiment the fourth and fifth steps of the process of the thermal coating are conducted with an Air Plasma Spray that expels and thus applies or deposits the TBC with air speeds from 100 to 400 m/s. This high speed application of the partially melted graded ceramic particles is an important feature of the process of applying the TBC described herein. The deposition of the thermal barrier coating includes depositing each layer of the TBC on the substrate to a thickness in the range of from about 1.0 to about 50 mils, and more preferably depositing each layer of the TBC to a thickness in the range of from about 1.0 to about 15 mils.

Thus changing the TBC elemental composition refers to changing from a cubic fluorite structure, the structure of zirconium oxide stabilized by yttrium oxide, to a cubic pyrochlore, or near pyrochlore crystal structure. The cubic pyrochlore structure is typified by a composition A,B,O, where A can have valance of 3⁺ or 2⁺ and B can have a valance of 4⁺ or 5⁺ and wherein the sum of the A and B valences is 7.

Typical pyrochlores which we believe to have potential as thermal barrier coatings are those in which A is selected from the group consisting of lanthanum, gadolinium and yttrium and mixtures thereof and B is selected from the group consisting of zirconium, hafnium and titanium and ceramic materials, when applied according to certain mixtures thereof. Although the pyrochlore and fluorite structure are closely related, substitution of a high concentration of high atomic mass atoms (lanthanum, gadolinium and yttrium) into the fluorite structure provides a means to lower thermal conductivity that does not readily exist with stabilized zirconia compounds.

Reduction in thermal conductivity has also been associated with increasing complexity of crystallographic structure. The pyrochlore structure exhibits a greater degree of complexity than the fluorite structure. The cubic pyrochlore structure is similar to the cubic fluorite structure but with a large number of the oxygen atoms displaced (and one in eight missing). Lanthanum zirconate, neodymium titanate, and gadolinium hafnate are all pyrochlore structure formers. Gadolinia zirconia oxide is a weak pyrochlore former, as indicated by the fact that the ionic radii of gadolinia and zirconia are relatively large, near the edge of pyrochlore forming region. Gadolinia and zirconia prepared in a composition and temperature expected to form pyrochlore structure actually exhibits either the fluorite structure or a combination of the fluorite structure and the pyrochlore structure.

The final step 20 described in FIG. 2 is the optional curing/drying/and a further application of another TBC coating with the repetition of steps 12 to 18 inclusively, on top of a previously prepared TBC.

The TBC described herein provides the combination of nano-structured TBC with intrinsic lower thermal conductivity through coating chemical composition. The TBC described herein enables the coated component to benefit from, among other things, improved metal substrate and bond coat oxidation life, improved TBC spallation life, lower operating costs from an improved durability and/or increased engine performance from higher operating temperatures (for example a higher combustion chamber exit temperature (T4)) or reduction in cooling air requirements for cooled component.

The above description is meant to be exemplary only, and one skilled in the art will recognize that changes may be made to the embodiments described without departing form the spirit of the invention. Still other modifications which fall within the scope of the present invention will be apparent to those skilled in the art, in light of a review of this disclosure and such modifications are intended to fall within the appended claims.

What is claimed is:

1. A thermal barrier coating for application to a substrate comprising:
a ceramic based compound comprising gadolinia and zirconia; and
nano-structured porous inclusions in the compound, wherein the coating comprises a nano-structure having a porosity of at most 50% by volume.

2. The coating of claim 1, wherein said ceramic based compound consists essentially of GSZ.

3. The coating of claim 1, wherein the compound comprises zirconia with between about 5 to 60 mol. % gadolinia.

4. The coating of claim 1, wherein the porosity is at most 20% by volume of the coating.

5. The coating of claim 1, wherein the gadolinia and zirconia reacts with at least one silicate for form a reaction product.

6. The coating of claim 1, wherein the substrate is a surface of at least one of an airfoil, a seal, and a combustion chamber liner of a gas turbine engine.

7. The coating of claim 6, wherein the substrate includes at least the airfoil of a turbine vane of a gas turbine engine.

8. The coating of claim 1, wherein the substrate is composed of a material selected from the group consisting of nickel based alloy, cobalt based alloy, steel alloy, and molybdenum based alloy.

9. The coating of claim 1, further comprising a metallic bond coat disposed between the substrate and the thermal barrier coating.

10. The coating of claim 9, wherein the metallic bond coat has a thickness in the range of from about 0.5 to about 20 mils.

11. The coating of claim 10, wherein the metallic bond coat has a thickness in the range of from about 0.5 to about 10 mils.

12. The coating of claim 1, wherein the thermal barrier coating has a thickness in the range of from about 1.0 to about 50 mils.

13. The coating of claim 12, wherein the thermal barrier coating has a thickness in the range of from about 1.0 to about 15 mils.

14. A process for applying a thermal barrier coating onto a substrate, the process comprising:
providing a particulate ceramic based compound comprising gadolinium zirconate;
grading the particulate ceramic based compound to produce graded particles comprising nanosized particles, wherein the nanosized particles have an average diameter from 2nm to 400 nm, collecting the graded particles;
at least partially melting an outer surface of a majority of the graded particles; and
applying the partially melted graded particles onto the substrate to produce the coating comprising a porosity of at most 50% by volume of the coating.

15. The process of claim 14, further comprising applying the thermal barrier coating to a thickness in the range of from about 1.0 to about 50 mils.

16. The process of claim 14, wherein the applying is of partially melted agglomerated graded particles.
